(19) United States
(12) Patent Application Publication
(10) Pub. No.: US 2026/0050489 A1
(43) Pub. Date: Feb. 19, 2026

(54) SYSTEM FOR MANAGING STATES OF VIRTUAL WAREHOUSES

(71) Applicant: Snowflake Inc., Bozeman, MT (US)

(72) Inventors: Prayag Chandran Nirmala, Seattle, WA (US); Lonnie Princehouse, Mercer Island, WA (US); Jeffrey Rosen, San Mateo, CA (US); Michael Uhlar, Fox Island, WA (US)

(21) Appl. No.: 18/804,924

(22) Filed: Aug. 14, 2024

(51) Int. Cl. G06F 9/50; G06F 9/48

(52) U.S. Cl. CPC G06F 9/5083; G06F 9/4881

(57) ABSTRACT

Techniques for managing states of virtual warehouses in a multi-tenant network-based data system are described. A “resolver” may be provided in each warehouse scheduling service thread. The resolver may maintain a current state of the virtual warehouse and may generate a target state of the virtual warehouse based on an operation request, such as a resume operation, a suspend operation, resize operation, etc. The resolver may generate an action plan to converge the current state to the target state.

### TECHNICAL FIELD

The present disclosure generally relates to data systems, such as data warehouses, and, more specifically, to managing states of virtual warehouses at scale.

### BACKGROUND

As the world becomes more data driven, database systems and other data systems are storing more and more data. For a business to use this data, different operations or queries are typically run on this large amount of data. Some operations, for example, those including large table scans or executing multiple queries, can take a substantial amount of time to execute on a large amount of data. The time to execute such operations can be proportional to the number of computing resources used for execution, so time can be shortened using more computing resources.

Some data systems can provide a pool of computing resources, and those resources can be assigned to execute different operations. However, in such systems, the assigned computing resources typically work in conjunction, for example in a cluster group. Their assignments are fixed and static. That is, a computing resource can remain assigned to an operation, which no longer needs that computing resource. The assignments of those computing resources cannot be easily modified in response to demand changes.

### BRIEF DESCRIPTION OF THE DRAWINGS

Various ones of the appended drawings merely illustrate example embodiments of the present disclosure and should not be considered as limiting its scope.

FIG. 1 illustrates an example computing environment, according to some example embodiments.

FIG. 2 is a block diagram illustrating components of a compute service manager, according to some example embodiments.

FIG. 3 is a block diagram illustrating components of an execution platform, according to some example embodiments.

FIG. 4 is a block diagram of a framework for virtual warehouse management, according to some example embodiments.

FIG. 5 is a network flow for virtual warehouse management, according to some example embodiments.

FIG. 6 is a flow diagram for a method for managing virtual warehouse states, according to some example embodiments.

FIG. 7 is a flow diagram of a method to remove a server from a warehouse cluster, according to some example embodiments.

FIG. 8 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Described herein are techniques for managing states of virtual warehouses in a multi-tenant network-based data system. A “resolver” may be provided in each warehouse scheduling service thread. The resolver may maintain a current state of the virtual warehouse and may generate a target state of the virtual warehouse based on an operation request, such as a resume operation, a suspend operation, resize operation, etc. The resolver may generate an action plan to converge the current state to the target state. The action plan may include steps that are iteratively executed until the current state matches the target state. The action plan may include allocation requests to a server management service for allocations or deallocations of servers. Therefore, the state of each virtual warehouse is managed separately by respective resolvers, and the state of each virtual warehouse can be quickly modified to accommodate fluctuating data processing needs, such as queries. Latency in data processing by the virtual warehouses is significantly reduced.

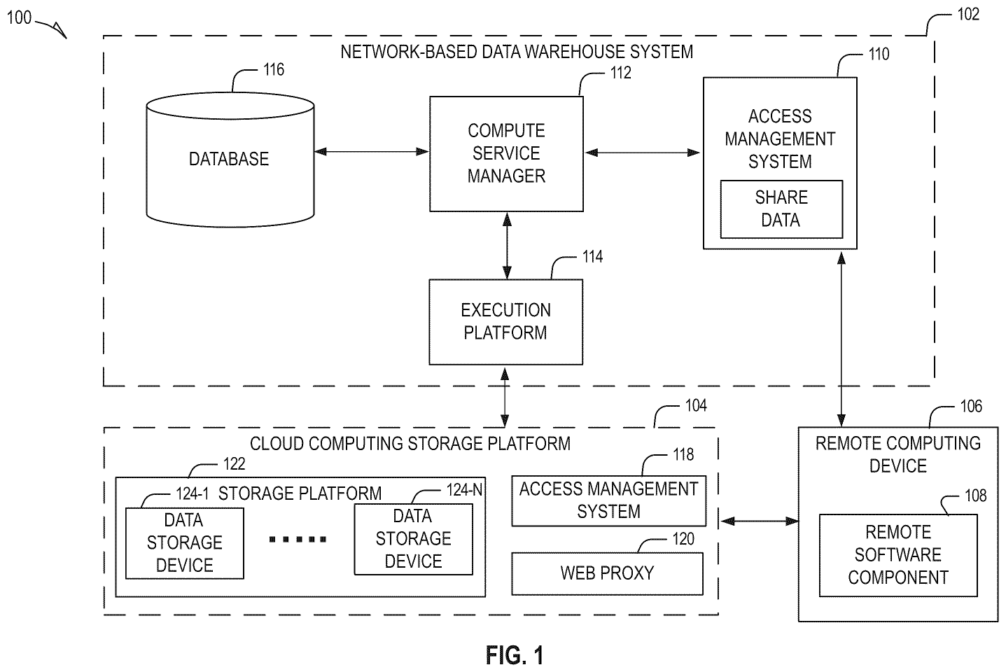

FIG. 1 illustrates an example shared data processing platform 100. To avoid obscuring the inventive subject matter with unnecessary detail, various functional components that are not germane to conveying an understanding of the inventive subject matter have been omitted from the figures. However, a skilled artisan will readily recognize that various additional functional components may be included as part of the shared data processing platform 100 to facilitate additional functionality that is not specifically described herein.

As shown, the shared data processing platform 100 comprises the network-based database system 102, a cloud computing storage platform 104 (e.g., a storage platform, an AWS® service, Microsoft Azure®, or Google Cloud Services®), and a remote computing device 106. The network-based database system 102 is a cloud database system used for storing and accessing data (e.g., internally storing data, accessing external remotely located data) in an integrated manner, and reporting and analysis of the integrated data from the one or more disparate sources (e.g., the cloud computing storage platform 104). The cloud computing storage platform 104 comprises a plurality of computing machines and provides on-demand computer system resources such as data storage and computing power to the network-based database system 102. While in the embodiment illustrated in FIG. 1, a data warehouse is depicted, other embodiments may include other types of databases or other data processing systems.

The remote computing device 106 (e.g., a user device such as a laptop computer) comprises one or more computing machines (e.g., a user device such as a laptop computer) that execute a remote software component 108 (e.g., browser accessed cloud service) to provide additional functionality to users of the network-based database system 102. The remote software component 108 comprises a set of machine-readable instructions (e.g., code) that, when executed by the remote computing device 106, cause the remote computing device 106 to provide certain functionality. The remote software component 108 may operate on input data and generates result data based on processing, analyzing, or otherwise transforming the input data. As an example, the remote software component 108 can be a data provider or data consumer that enables database tracking procedures.

The network-based database system 102 comprises an access management system 110, a compute service manager 112, an execution platform 114, and a database 116. The access management system 110 enables administrative users to manage access to resources and services provided by the network-based database system 102. Administrative users can create and manage users, roles, and groups, and use permissions to allow or deny access to resources and services. The access management system 110 can store shared data that securely manages shared access to the storage resources of the cloud computing storage platform 104 amongst different users of the network-based database system 102, as discussed in further detail below.

The compute service manager 112 coordinates and manages operations of the network-based database system 102. The compute service manager 112 also performs query optimization and compilation as well as managing clusters of computing services that provide compute resources (e.g., virtual warehouses, virtual machines, EC2 clusters). The compute service manager 112 can support any number of client accounts such as end users providing data storage and retrieval requests, system administrators managing the systems and methods described herein, and other components/devices that interact with compute service manager 112.

The compute service manager 112 is also coupled to database 116, which is associated with the entirety of data stored on the shared data processing platform 100. The database 116 stores data pertaining to various functions and aspects associated with the network-based database system 102 and its users.

In some embodiments, database 116 includes a summary of data stored in remote data storage systems as well as data available from one or more local caches. Additionally, database 116 may include information regarding how data is organized in the remote data storage systems and the local caches. Database 116 allows systems and services to determine whether a piece of data needs to be accessed without loading or accessing the actual data from a storage device. The compute service manager 112 is further coupled to an execution platform 114, which provides multiple computing resources (e.g., virtual warehouses) that execute various data storage and data retrieval tasks, as discussed in greater detail below.

Execution platform 114 is coupled to multiple data storage devices 124-1 to 124-N that are part of a cloud computing storage platform 104. In some embodiments, data storage devices 124-1 to 124-N are cloud-based storage devices located in one or more geographic locations. For example, data storage devices 124-1 to 124-N may be part of a public cloud infrastructure or a private cloud infrastructure. Data storage devices 124-1 to 124-N may be hard disk drives (HDDs), solid state drives (SSDs), storage clusters, Amazon S3 storage systems or any other data storage technology. Additionally, cloud computing storage platform 104 may include distributed file systems (such as Hadoop Distributed File Systems (HDFS)), object storage systems, and the like.

The execution platform 114 comprises a plurality of compute nodes (e.g., virtual warehouses). A set of processes on a compute node executes a query plan compiled by the compute service manager 112. The set of processes can include: a first process to execute the query plan; a second process to monitor and delete micro-partition files using a least recently used (LRU) policy, and implement an out of memory (OOM) error mitigation process; a third process that extracts health information from process logs and status information to send back to the compute service manager 112; a fourth process to establish communication with the compute service manager 112 after a system boot; and a fifth process to handle all communication with a compute cluster for a given job provided by the compute service manager 112 and to communicate information back to the compute service manager 112 and other compute nodes of the execution platform 114.

The cloud computing storage platform 104 also comprises an access management system 118 and a web proxy 120. As with the access management system 110, the access management system 118 allows users to create and manage users, roles, and groups, and use permissions to allow or deny access to cloud services and resources. The access management system 110 of the network-based database system 102 and the access management system 118 of the cloud computing storage platform 104 can communicate and share information so as to enable access and management of resources and services shared by users of both the network-based database system 102 and the cloud computing storage platform 104. The web proxy 120 handles tasks involved in accepting and processing concurrent API calls, including traffic management, authorization and access control, monitoring, and API version management. The web proxy 120 provides HTTP proxy service for creating, publishing, maintaining, securing, and monitoring APIs (e.g., REST APIs).

In some embodiments, communication links between elements of the shared data processing platform 100 are implemented via one or more data communication networks. These data communication networks may utilize any communication protocol and any type of communication medium. In some embodiments, the data communication networks are a combination of two or more data communication networks (or sub-Networks) coupled to one another. In alternative embodiments, these communication links are implemented using any type of communication medium and any communication protocol.

As shown in FIG. 1, data storage devices 124-1 to 124-N are decoupled from the computing resources associated with the execution platform 114. That is, new virtual warehouses can be created and terminated in the execution platform 114 and additional data storage devices can be created and terminated on the cloud computing storage platform 104 in an independent manner. This architecture supports dynamic changes to the network-based database system 102 based on the changing data storage/retrieval needs as well as the changing needs of the users and systems accessing the shared data processing platform 100. The support of dynamic changes allows network-based database system 102 to scale quickly in response to changing demands on the systems and components within network-based database system 102. The decoupling of the computing resources from the data storage devices 124-1 to 124-N supports the storage of large amounts of data without requiring a corresponding large amount of computing resources. Similarly, this decoupling of resources supports a significant increase in the computing resources utilized at a particular time without requiring a corresponding increase in the available data storage resources. Additionally, the decoupling of resources enables different accounts to handle creating additional compute resources to process data shared by other users without affecting the other users' systems. For instance, a data provider may have three compute resources and share data with a data consumer, and the data consumer may generate new compute resources to execute queries against the shared data, where the new compute resources are managed by the data consumer and do not affect or interact with the compute resources of the data provider.

Compute service manager 112, database 116, execution platform 114, cloud computing storage platform 104, and remote computing device 106 are shown in FIG. 1 as individual components. However, each of compute service manager 112, database 116, execution platform 114, cloud computing storage platform 104, and remote computing environment may be implemented as a distributed system (e.g., distributed across multiple systems/platforms at multiple geographic locations) connected by APIs and access information (e.g., tokens, login data). Additionally, each of compute service manager 112, database 116, execution platform 114, and cloud computing storage platform 104 can be scaled up or down (independently of one another) depending on changes to the requests received and the changing needs of shared data processing platform 100. Thus, in the described embodiments, the network-based database system 102 is dynamic and supports regular changes to meet the current data processing needs.

During typical operation, the network-based database system 102 processes multiple jobs (e.g., queries) determined by the compute service manager 112. These jobs are scheduled and managed by the compute service manager 112 to determine when and how to execute the job. For example, the compute service manager 112 may divide the job into multiple discrete tasks and may determine what data is needed to execute each of the multiple discrete tasks. The compute service manager 112 may assign each of the multiple discrete tasks to one or more nodes of the execution platform 114 to process the task. The compute service manager 112 may determine what data is needed to process a task and further determine which nodes within the execution platform 114 are best suited to process the task. Some nodes may have already cached the data needed to process the task (due to the nodes having recently downloaded the data from the cloud computing storage platform 104 for a previous job) and, therefore, be a good candidate for processing the task. Metadata stored in the database 116 assists the compute service manager 112 in determining which nodes in the execution platform 114 have already cached at least a portion of the data needed to process the task. One or more nodes in the execution platform 114 process the task using data cached by the nodes and, if necessary, data retrieved from the cloud computing storage platform 104. It is desirable to retrieve as much data as possible from caches within the execution platform 114 because the retrieval speed is typically much faster than retrieving data from the cloud computing storage platform 104.

As shown in FIG. 1, the shared data processing platform 100 separates the execution platform 114 from the cloud computing storage platform 104. In this arrangement, the processing resources and cache resources in the execution platform 114 operate independently of the data storage devices 124-1 to 124-N in the cloud computing storage platform 104. Thus, the computing resources and cache resources are not restricted to specific data storage devices 124-1 to 124-N. Instead, all computing resources and all cache resources may retrieve data from, and store data to, any of the data storage resources in the cloud computing storage platform 104.

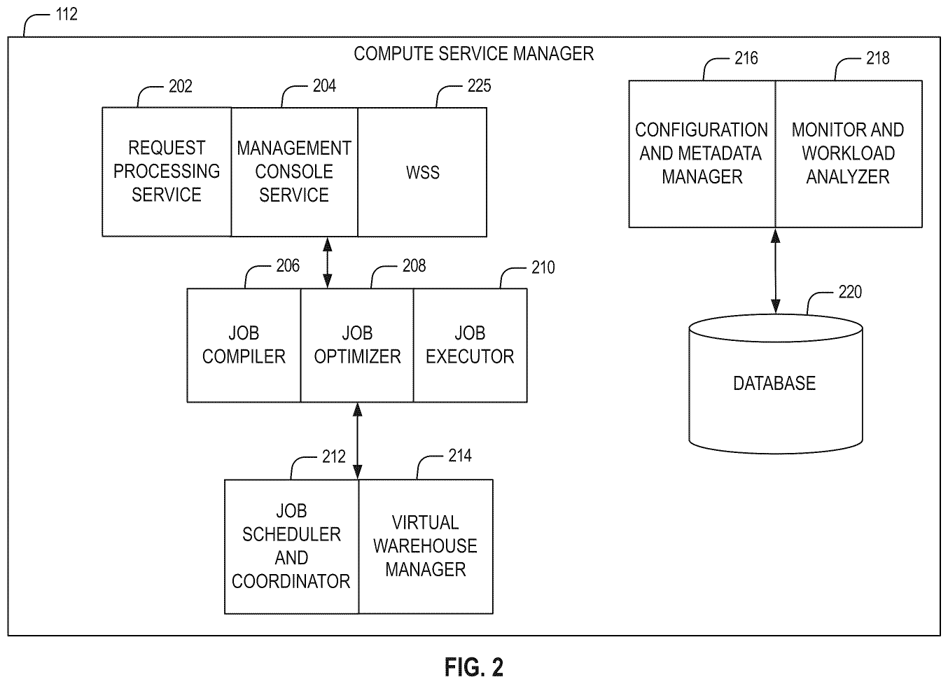

FIG. 2 is a block diagram illustrating components of the compute service manager 112, in accordance with some embodiments of the present disclosure. As shown in FIG. 2, a request processing service 202 manages received data storage requests and data retrieval requests (e.g., jobs to be performed on database data). For example, the request processing service 202 may determine the data necessary to process a received query (e.g., a data storage request or data retrieval request). The data may be stored in a cache within the execution platform 114 or in a data storage device in cloud computing storage platform 104. A management console service 204 supports access to various systems and processes by administrators and other system managers. Additionally, the management console service 204 may receive a request to execute a job and monitor the workload on the system.

The compute service manager 112 also includes a job compiler 206, a job optimizer 208, and a job executor 210. The job compiler 206 parses a job into multiple discrete tasks and generates the execution code for each of the multiple discrete tasks. The job optimizer 208 determines the best method to execute the multiple discrete tasks based on the data that needs to be processed. The job optimizer 208 also handles various data pruning operations and other data optimization techniques to improve the speed and efficiency of executing the job. The job executor 210 executes the execution code for jobs received from a queue or determined by the compute service manager 112.

A job scheduler and coordinator 212 sends received jobs to the appropriate services or systems for compilation, optimization, and dispatch to the execution platform 114. For example, jobs may be prioritized and processed in that prioritized order. In an embodiment, the job scheduler and coordinator 212 determines a priority for internal jobs that are scheduled by the compute service manager 112 with other “outside” jobs such as user queries that may be scheduled by other systems in the database but may utilize the same processing resources in the execution platform 114. In some embodiments, the job scheduler and coordinator 212 identifies or assigns particular nodes in the execution platform 114 to process particular tasks. A virtual warehouse manager 214 manages the operation of multiple virtual warehouses implemented in the execution platform 114. As discussed below, each virtual warehouse includes multiple execution nodes that each include a cache and a processor (e.g., a virtual machine, an operating system level container execution environment).

Additionally, the compute service manager 112 includes a configuration and metadata manager 216, which manages the information related to the data stored in the remote data storage devices and in the local caches (i.e., the caches in execution platform 114). The configuration and metadata manager 216 uses the metadata to determine which data micro-partitions need to be accessed to retrieve data for processing a particular task or job. A monitor and workload analyzer 218 oversees processes performed by the compute service manager 112 and manages the distribution of tasks (e.g., workload) across the virtual warehouses and execution nodes in the execution platform 114. The monitor and workload analyzer 218 also redistributes tasks, as needed, based on changing workloads throughout the network-based database system 102 and may further redistribute tasks based on a user (e.g., “external”) query workload that may also be processed by the execution platform 114. The configuration and metadata manager 216 and the monitor and workload analyzer 218 are coupled to a data storage device 220. Data storage device 220 in FIG. 2 represent any data storage device within the network-based database system 102. For example, data storage device 220 may represent caches in execution platform 114, storage devices in cloud computing storage platform 104, or any other storage device.

In some example embodiments, the compute service manager 112 may also include a Warehouse Scheduling Service (WSS) 225 as described in further detail below. The WSS 225 may manage the state of respective virtual warehouses, such as the size and configuration of virtual warehouses. The WSS 225 may interact with the metadata database to determine target states of respective warehouses and compare the target states to current states (or topologies) of the virtual warehouses. The WSS 225 may then generate an action plan to bring the current state to the target state. The WSS 225 may communicate with a Server Management Service (SMS) to request allocation (or deallocations) of computing resources (e.g., execution platforms) to bring the current state of the respective virtual warehouse to the target state, as described in further detail below.

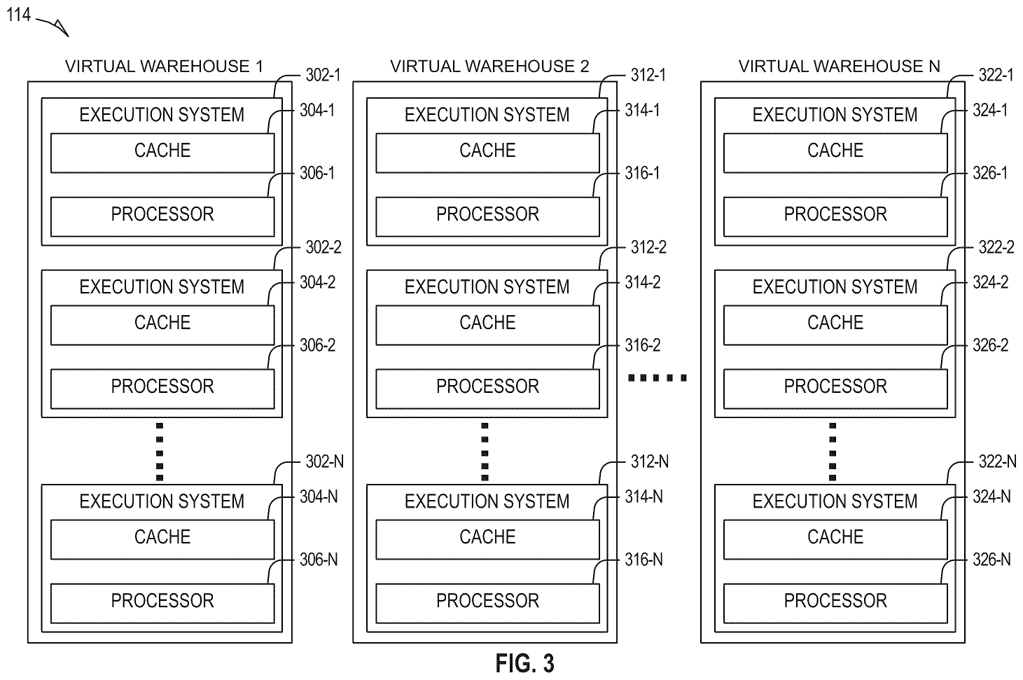

FIG. 3 is a block diagram illustrating components of the execution platform 114, in accordance with some embodiments of the present disclosure. As shown in FIG. 3, execution platform 114 includes multiple virtual warehouses, which are elastic clusters of compute instances, such as virtual machines. In the example illustrated, the virtual warehouses include virtual warehouse 1, virtual warehouse 2, and virtual warehouse n. Each virtual warehouse (e.g., EC2 cluster) includes multiple execution nodes (e.g., virtual machines) that each include a data cache and a processor. The virtual warehouses can execute multiple tasks in parallel by using the multiple execution nodes. As discussed herein, execution platform 114 can add new virtual warehouses and drop existing virtual warehouses in real time based on the current processing needs of the systems and users. This flexibility allows the execution platform 114 to quickly deploy large amounts of computing resources when needed without being forced to continue paying for those computing resources when they are no longer needed. All virtual warehouses can access data from any data storage device (e.g., any storage device in cloud computing storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary (e.g., upon a query or job completion).

Each virtual warehouse is capable of accessing any of the data storage devices 124-1 to 124-N shown in FIG. 1. Thus, the virtual warehouses are not necessarily assigned to a specific data storage device 124-1 to 124-N and, instead, can access data from any of the data storage devices 124-1 to 124-N within the cloud computing storage platform 104. Similarly, each of the execution nodes shown in FIG. 3 can access data from any of the data storage devices 124-1 to 124-N. For instance, the storage device 124-1 of a first user (e.g., provider account user) may be shared with a worker node in a virtual warehouse of another user (e.g., consumer account user), such that the other user can create a database (e.g., read-only database) and use the data in storage device 124-1 directly without needing to copy the data (e.g., copy it to a new disk managed by the consumer account user). In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data the execution nodes are caching. For example, these execution nodes do not store or otherwise maintain state information about the execution node, or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each include one data cache and one processor, alternative embodiments may include execution nodes containing any number of processors and any number of caches. Additionally, the caches may vary in size among the different execution nodes. The caches shown in FIG. 3 store, in the local execution node (e.g., local disk), data that was retrieved from one or more data storage devices in cloud computing storage platform 104 (e.g., S3 objects recently accessed by the given node). In some example embodiments, the cache stores file headers and individual columns of files as a query downloads only columns necessary for that query.

To improve cache hits and avoid overlapping redundant data stored in the node caches, the job optimizer 208 assigns input file sets to the nodes using a consistent hashing scheme to hash over table file names of the data accessed (e.g., data in database 116 or database 122). Subsequent or concurrent queries accessing the same table file will therefore be performed on the same node, according to some example embodiments.

As discussed, the nodes and virtual warehouses may change dynamically in response to environmental conditions (e.g., disaster scenarios), hardware/software issues (e.g., malfunctions), or administrative changes (e.g., changing from a large cluster to smaller cluster to lower costs). In some example embodiments, when the set of nodes changes, no data is reshuffled immediately. Instead, the least recently used replacement policy is implemented to eventually replace the lost cache contents over multiple jobs. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud computing storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the execution platform 114 implements skew handling to distribute work amongst the cache resources and computing resources associated with a particular execution, where the distribution may be further based on the expected tasks to be performed by the execution nodes. For example, an execution node may be assigned more processing resources if the tasks performed by the execution node become more processor-intensive. Similarly, an execution node may be assigned more cache resources if the tasks performed by the execution node require a larger cache capacity. Further, some nodes may be executing much slower than others due to various issues (e.g., virtualization issues, network overhead). In some example embodiments, the imbalances are addressed at the scan level using a file stealing scheme. In particular, whenever a node process completes scanning its set of input files, it requests additional files from other nodes. If the one of the other nodes receives such a request, the node analyzes its own set (e.g., how many files are left in the input file set when the request is received), and then transfers ownership of one or more of the remaining files for the duration of the current job (e.g., query). The requesting node (e.g., the file stealing node) then receives the data (e.g., header data) and downloads the files from the cloud computing storage platform 104 (e.g., from data storage device 124-1), and does not download the files from the transferring node. In this way, lagging nodes can transfer files via file stealing in a way that does not worsen the load on the lagging nodes.

Although virtual warehouses 1, 2, and n are associated with the same execution platform 114, the virtual warehouses may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and implements execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 114 is also fault tolerant. For example, if one virtual warehouse fails, that virtual warehouse is quickly replaced with a different virtual warehouse at a different geographic location.

A particular execution platform 114 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in cloud computing storage platform 104, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

Virtual warehouse management techniques are described next. As mentioned above, a WSS manages warehouse states, such as size and type of execution platform (XP) servers (e.g., execution platforms 114). Each warehouse may have a corresponding WSS for management purposes. For example, a compute service manager may include a plurality of WSS threads, each thread corresponding to a different virtual warehouse. The multi-tenant network-based data system may include a plurality of compute service managers, each with a plurality of WSS threads.

A service referred to as a “resolver” is provided per WSS thread, which maintains the current state and the target state of the respective virtual warehouse. The WSS may morph or mutate the target state to reflect the desired effects of requested operations. The resolver may generate and then execute a plan to modify the current state to match the target state. This plan may take several iterations to complete, so convergence may not be immediate, thereby making the system eventually consistent. The resolver may periodically or on-trigger communicate with the SMS to add, remove, or replace XP servers to ensure current warehouse topology matches the target cluster state.

The SMS can handle the free pool of XPs (e.g., servers) and can communicate with the plurality of WSSs for XP allocation requests. Requests for XPs, relinquishing XPs, or reads of XPs may be managed through the SMS.

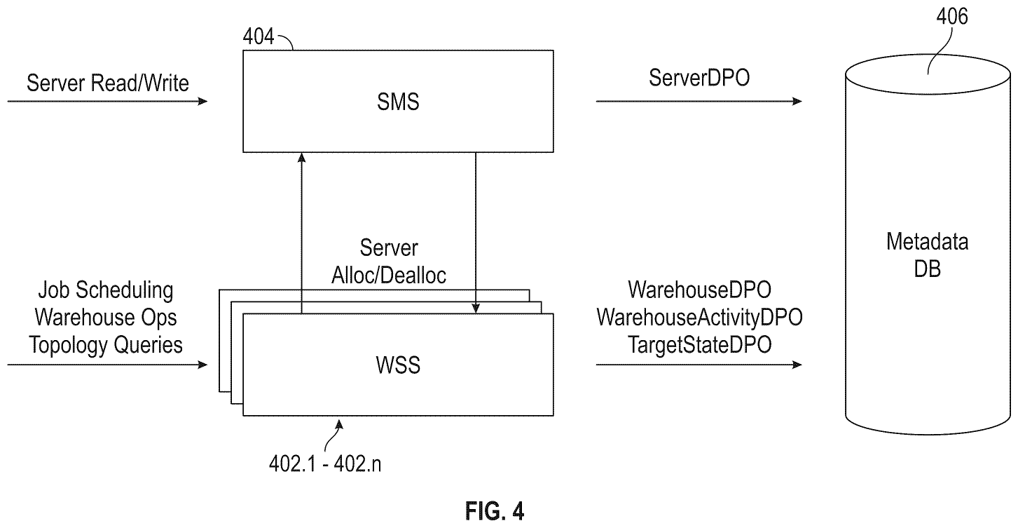

FIG. 4 is a block diagram of a framework for virtual warehouse management, according to some example embodiments. A plurality of WSSs 402.1-402.n are communicatively coupled to the SMS 404. The plurality of WSSs 402.1-402.n may write metadata, such as data persistent objects (DPOs), pertaining to warehouse state management to metadata database 406. For example, the WSSs 402.1-402.n may write a WarehouseDPO, which may include information regarding the configuration of a created warehouse; a WarehouseActivityDPO, which may include information regarding activity of the warehouse; and a TargetStateDPO, which may include information regarding the target state of the warehouse.

As mentioned above, the plurality of WSSs 402.1-402.n manages respective virtual warehouses. That is, WSS 402.1 may manage a first virtual warehouse, WSS 402.2 may manage a second virtual warehouse, and so on. The WSSs 402.1-402.n may receive inputs, such as job scheduling, warehouse operations, and topology queries. As described in further detail below, respective WSSs 402.1-402.n may set a target state of the state of the respective warehouse based on the received input and other information. The WSSs 402.1-402.n may also receive a current state (or topology) of the respective warehouse and may generate a plan to bring the current state to the target state. The plan may include transmitting allocation (and deallocation) requests to the SMS 404. Steps of the plan may be performed in an iterative fashion until the current state of the virtual warehouse reaches the target state. Notably, during the iterative process, the target state of the virtual warehouse may be changed, and the respective WSS 402.1-402.n may use the updated target state in the next iterative step.

The SMS 404 may be provided as a single-node dedicated service. The SMS 404 may write XP server metadata (e.g., ServerDPO) to the metadata database 406. Changes to XP servers go through the SMS 404. The SMS 404 is positioned as the single point in the data system for allocating XP servers as the SMS 404 has a global view of the XP servers in the data system. The SMS 404 may maintain a write-through cache of XP server metadata, which SMS 404 may use to index the free pool for fast allocation searches.

In some example embodiments, the SMS 404 may also include a cluster manager. Virtual warehouses may include one or more clusters, where each cluster includes one or more XP servers. The cluster manager may perform server maintenance tasks. The cluster manager may periodically perform maintenance on the servers on a warehouse list. Because the cluster manager is located in the SMS 404 (e.g., operating on the same Java Virtual Machine (JVM)), the list of servers may be retrieved from the in-memory server cache rather than having to perform a scan read of the metadata database 406, which can be expensive and time consuming.

The SMS 404 may include a plurality of APIs. A free pool API may be used to search, allocate from, and deallocate to the free pool of XP servers. The WSS 402.1-402.n may call the free pool API to change warehouse clusters, as described in further detail below. A server write API may wrap legacy metadata database transactions related to server business logic. These transactions may include server lifecycle transitions (e.g., provisioning, binary download, release), health checks, etc. A server read API may handle server reads. The server reads may include simple lookups and more complex queries, such as “read all servers in this cluster.”

The free pool API may be cluster-based. That is, respective API requests operate on a specified cluster, identified by a cluster id (e.g., (account_id, warehouse_id, cluster_id). For warehouses with a plurality of clusters, the WSS may transmit different allocation requests to the SMS 404 for each cluster. In some examples, the SMS 404 may allow only one request at a time for each respective cluster. The cluster identifier may be used to specify the current request for the given cluster (which may be executing or queued). The SMS may reject new requests if there is an ongoing request for that warehouse cluster. Cancellation responses may indicate if the request was partially completed, as described in further detail below. If so the WSS may reload the topology and recalculate actions to achieve the target state of the warehouse cluster.

The free pool API may perform different changes to clusters, such as add servers, remove servers, and replace servers. In some examples, the different operations may be grouped together in a single function, such as an alter cluster function. The alter_cluster function by a WSS can add, replace, and remove servers for a cluster in a single request rather than having to transmit multiple requests.

The SMS 404 may include a server-side queue. The SMS 404 may execute requests quickly when resources (e.g., servers) are available. The server-side queue may include operations waiting on resources. In some examples, the server-side queue may be in a “soft state,” such that the server-side queue may exist only in memory on the SMS 404. In these examples, queued requests may be lost in the event of an SMS crash. The WSSs 402.1-402.n may periodically check on the status of requests and may issue new requests if requests are timed out.

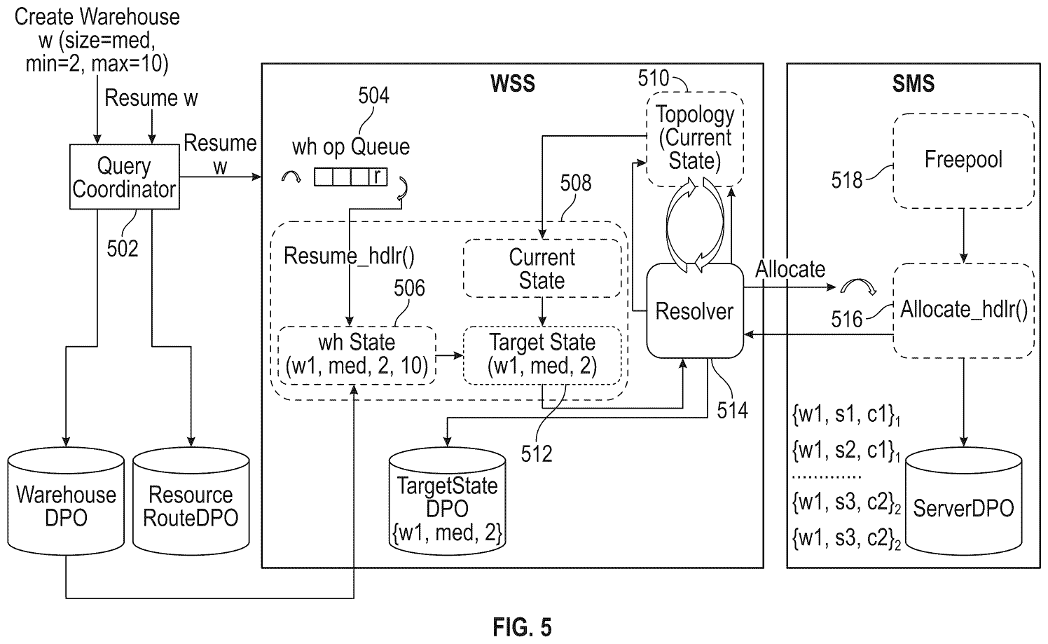

FIG. 5 is a network flow for virtual warehouse management, according to some example embodiments. A query coordinator 502 receives a create warehouse command. The create warehouse command may be transmitted by a user of the data system to generate a virtual warehouse with a specified state. In the example shown in FIG. 5, the requested warehouse w is to include a minimum of two clusters, a maximum of 10 clusters, with each cluster being a medium size (e.g., two servers).

The query coordinator 502 writes metadata relating to the requested warehouse w in the WarehouseDPO. At this point, the warehouse w exists only as metadata and no actual resources (XP servers) have been allocated.

The query coordinator 502 receives an operation request for the warehouse, such as an indication to resume, suspend, resize, spinup, spindown, etc. the warehouse. The operation request may relate to changing the virtual warehouse properties.

For example, the operation request may include a manual resume command. In some examples, an auto-resume feature may be selected, and a reception of a query or other command can trigger a resume operation for the warehouse. In this example, the query coordinator 502 may write the resume operation in a ResourceRouteDPO in the metadata database. In some examples, the operation request may include an auto-suspend operation request of the virtual warehouse or a resizing operation request the virtual warehouse to a different configuration.

The query coordinator 502 transmits the operation request, such as the resume operation request, to WSS, which updates target state to reflect the effect of the operation. The target state can be immediately modified by the operation request.

In some examples, a warehouse operation queue (wh op queue) 504 in the WSS dedicated for warehouse w may be provided. The warehouse operation queue 504 may include other warehouse operations still being processed by the WSS. When the operation request comes to the top of the warehouse operation queue 504, a warehouse state (wh state) 506 is updated. The warehouse state 506 may be loaded from the WarehouseDPO for warehouse w. In the example, the warehouse state 506 is (w1, med, 2, 10). Also, a current state 508 of the warehouse w is loaded from a topology 510 of the warehouse w. Initially, the current state 508 of warehouse w is empty since no servers have been allocated to the warehouse.

A target state 512 is generated based on the warehouse state 506 and the current state 508. The target state 512 may include size of warehouse, subtype, virtual instance type, instance type, server count per cluster, minimum cluster count, and maximum cluster count. In some examples, the target state 512 may include compacted information. In the example, the target state 512 is (w1, med, 2) indicated two clusters with medium instance types (e.g., two servers per cluster). The target state 512 is written to the TargetStateDPO.

A resolver 514 reads the target state 512 from the TargetStateDPO and reads the current state/topology of the warehouse. The resolver 514 generates an action plan to converge the current state of the warehouse to the target state 512. The resolver 514 may transmit one or more allocation requests to the SMS based on the action plan. The allocation requests may be cluster-specific. That is, the resolver 514 may transmit one allocation request for a first cluster of warehouse w and a second allocation request for a second cluster of warehouse w. The allocation requests may be an alter_cluster request, as described above. The allocation requests may be transmitted to the SMS via gRPC.

An allocation handler 516 in the SMS may receive the one or more allocation requests. The allocation handler 516 has a list of free resources in the free pool 518. The allocation handler 516 may assign free resources to the clusters based on the allocation requests. As described above, a sever-side queue may be provided, and requests may be placed in the server-side queue if there are no free resources. In some examples, the allocations requests may not be fulfilled completely. For example, if an allocation request includes a request for eight servers and the free pool only includes four servers at the moment, the allocation handler 516 may only assign those four servers fulfilling a part of the allocation request.

The allocation handler 516 writes the allocated servers and topology to the ServerDPO. The allocation handler 516 also transmits a notification of the execution of the allocation request to the resolver 514. The resolver 514 updates the topology 510 accordingly. The topology 510, in turn, loads the current state 508. The resolver 514 may then operate in an iterative fashion until the current state 508 matches the target state 512. When the current state 508 matches the target state 512, the resolver 514 may delete the target state information in the TargetStateDPO, ending the iterative process.

The warehouse management techniques described herein use a target state, which can be changed by different components, and the resolver may have no knowledge of what component or operation changed the target state of the warehouse. Unlike some conventional systems where the warehouse size is dictated by the specific operation being performed, the target state of the warehouse using the techniques described herein can be based on different factors. Other components such as a scheduler and autoscaler may also update the target state. For example, a job scheduler may update the target state based on types of jobs and the size of the jobs. An autoscaler component may update the target state to scale the virtual warehouse based on demand needs of the entire data system. The target state is updated by writing to the TargetStateDPO.

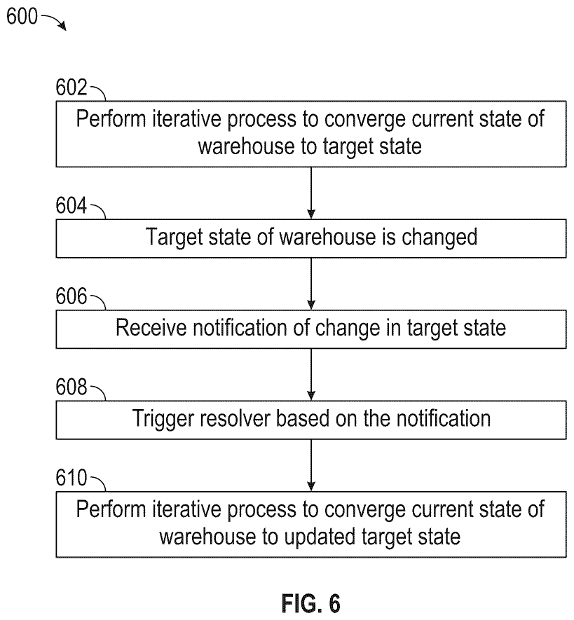

FIG. 6 is a flow diagram for a method 600 for managing virtual warehouse states, according to some example embodiments. At operation 602, a resolver may be performing the iterative process of converging the current state of the warehouse to the target state, as described above for example with reference to FIG. 5.

At operation 604, the target state of the warehouse is changed. For example, another component, such as a scheduler or autoscaler, has changed the target state of the warehouse by writing to the TargetStateDPO.

At operation 606, the resolver receives a notification of the change in the target state. At operation 608, the notification triggers the resolver to run its resolving process based on the updated target state. In some examples, actions (such as allocation requests) in flight related to the old target state may be cancelled. In other examples, the actions in flight may be allowed to be completed before running the resolving process with the updated target state.

At operation 610, the resolver performs the iterative process for converging the current state of warehouse to the updated target state, as described above for example with reference to FIG. 5.

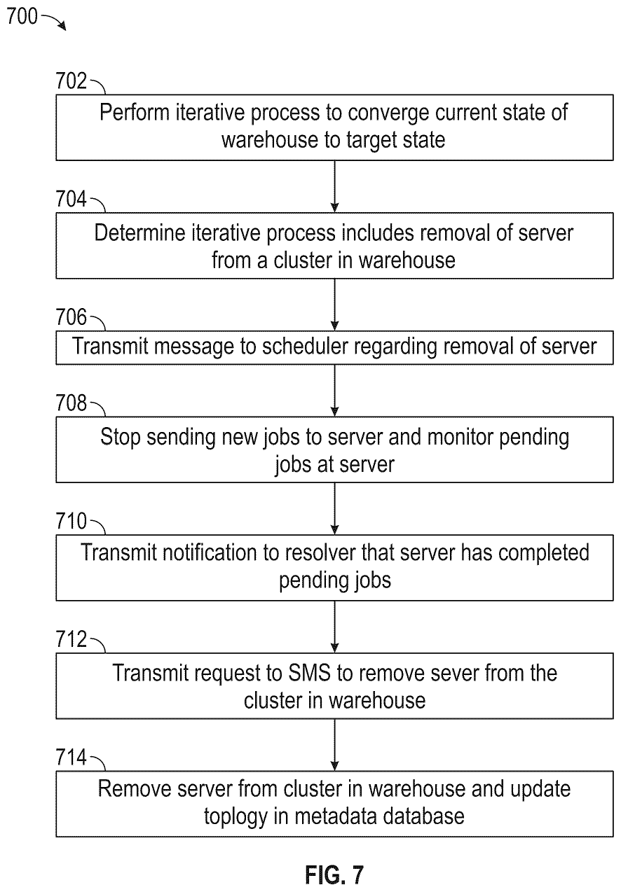

As mentioned above, the resolver can remove servers from a cluster in a warehouse. FIG. 7 is a flow diagram of a method 700 to remove an XP server from a warehouse cluster, according to some example embodiments. At operation 702, the resolver performs the iterative process for converging the current state of warehouse to the updated target state, as described above for example with reference to FIG. 5.

At operation 704, the resolver determines that the plan to bring the current state to the target state includes removing a server from a cluster in the warehouse. At operation 706, the resolver transmits a message to the scheduler regarding removing the server from the cluster in the warehouse. In some examples, the scheduler may be integrated with the WSS or provided in the same compute service manager as the WSS.

At operation 708, the scheduler stops sending new jobs to the identified server. Also, the scheduler monitors pending jobs at the identified server. At operation 710, the scheduler transmits a notification to the resolver that the identified server has completed all pending jobs, and no future jobs are scheduled (i.e., quiescing the server).

At operation 712, the resolver transmits a request to the SMS to remove the identified server from the cluster in the warehouse. For example, the resolver may transmit an alter_cluster request to remove the identified server from the specified cluster. At operation 714, the SMS removes the server from the specified cluster in the warehouse and writes the modified topology of the specified cluster to the metadata database (ServerDPO). The current topology of the warehouse is updated accordingly, notifying the resolver of the removal of the identified server.

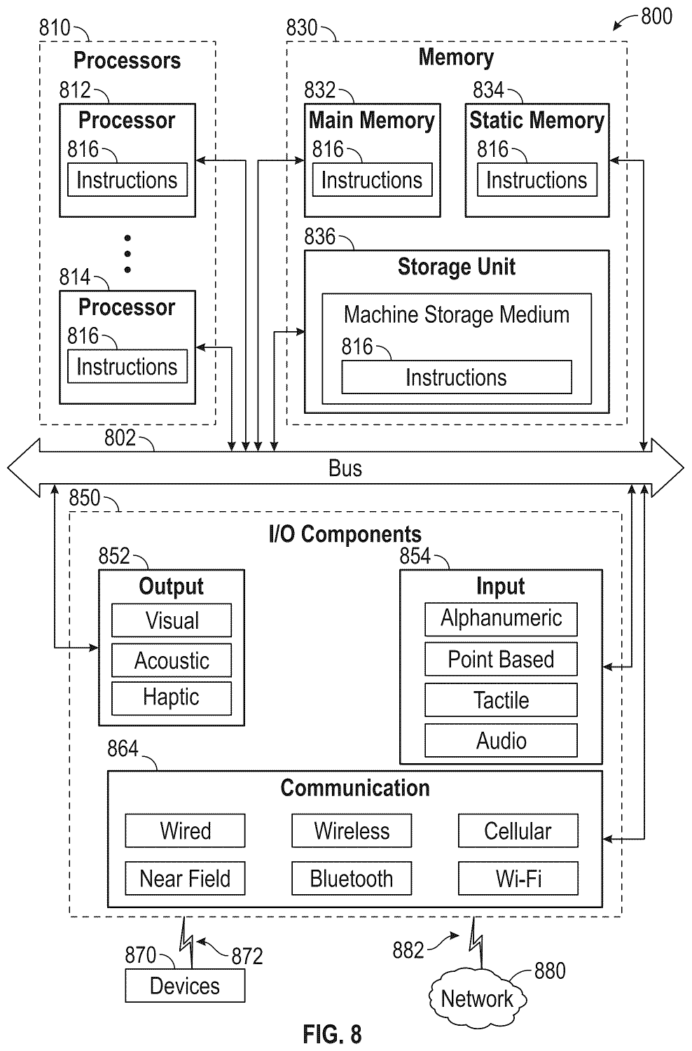

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute any one or more operations of any one or more of the methods described herein. As another example, the instructions 816 may cause the machine 800 to implement portions of the data flows described herein. In this way, the instructions 816 transform a general, non-programmed machine into a particular machine 800 (e.g., the remote computing device 106, the access management system 118, the compute service manager 112, the execution platform 114, the access management system 110, the Web proxy 120, remote computing device 106) that is specially configured to carry out any one of the described and illustrated functions in the manner described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 includes processors 810, memory 830, and input/output (I/O) components 850 configured to communicate with each other such as via a bus 802. In an example embodiment, the processors 810 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors 810 that may comprise two or more independent processors (sometimes referred to as “cores”) that may execute instructions 816 contemporaneously. Although FIG. 8 shows multiple processors 810, the machine 800 may include a single processor with a single core, a single processor with multiple cores (e.g., a multi-core processor), multiple processors with a single core, multiple processors with multiple cores, or any combination thereof.

The memory 830 may include a main memory 832, a static memory 834, and a storage unit 836, all accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 include components to receive input, provide output, produce output, transmit information, exchange information, capture measurements, and so on. The specific I/O components 850 that are included in a particular machine 800 will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, and other communication components to provide communication via other modalities. The devices 870 may be another machine or any of a wide variety of peripheral devices (e.g., a peripheral device coupled via a universal serial bus (USB)). For example, as noted above, the machine 800 may correspond to any one of the remote computing device 106, the access management system 118, the compute service manager 112, the execution platform 114, the access management system 110, the Web proxy 120, and the devices 870 may include any other of these systems and devices.

The various memories (e.g., 830, 832, 834, and/or memory of the processor(s) 810 and/or the storage unit 836) may store one or more sets of instructions 816 and data structures (e.g., software) embodying or utilized by any one or more of the methodologies or functions described herein. These instructions 816, when executed by the processor(s) 810, cause various operations to implement the disclosed embodiments.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methods described herein may be performed by one or more processors. The performance of certain of the operations may be distributed among the one or more processors, not only residing within a single machine, but also deployed across a number of machines. In some example embodiments, the processor or processors may be located in a single location (e.g., within a home environment, an office environment, or a server farm), while in other embodiments the processors may be distributed across a number of locations.

Although the embodiments of the present disclosure have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent, to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Described implementations of the subject matter can include one or more features, alone or in combination as illustrated below by way of example.

Example 1. A method comprising: receiving an operation request for a virtual warehouse in a multi-tenant network-based data system; transmitting the operation request for the virtual warehouse to a warehouse scheduling service dedicated to the virtual warehouse; generating, by at least one hardware processor, a target state of the virtual warehouse based on the operation request for the virtual warehouse; loading a current state of the virtual warehouse; generating an action plan to converge the current state to the target state; transmitting at least one allocation request to a server management service based on the action plan; and iteratively executing steps of the action plan until the current state matches the target state.

Example 2. The method of example 1, wherein the multi-tenant network-based data system comprises a plurality of warehouse scheduling services, each warehouse scheduling service being dedicated to a different virtual warehouse.

Example 3. The method of any of examples 1-2, wherein server management service is a single-node dedicated service and the multi-tenant network-based data system comprises a single server management service for managing a free pool of computing resources.

Example 4. The method of any of examples 1-3, wherein the at least one allocation request comprises a plurality of allocation requests, each allocation request of the plurality of allocation request corresponding to a different cluster in the virtual warehouse.

Example 5. The method of any of examples 1-4, further comprising: receiving from the server management service a notification of partial completion of the at least one allocation request; loading an updated current state of the virtual warehouse; comparing the updated current state and the target state; and transmitting at least a second allocation request to the server management service based on comparing the updated current state and the target state.

Example 6. The method of any of examples 1-5, further comprising: receiving a notification of a change to the target state that results in an updated target state; loading a current state of the virtual warehouse based on the notification; and generating an updated action plan to converge the current state to the updated target state.

Example 7. The method of any of examples 1-6, wherein the target state is changed by a different component than the warehouse scheduling service.

Example 8. The method of any of examples 1-7, wherein the operation request comprises a resume operation request.

Example 9. A system comprising: one or more processors of a machine; and a memory storing instructions that, when executed by the one or more processors, cause the machine to perform operations implementing any one of example methods 1 to 8.

Example 10. A machine-readable storage device embodying instructions that, when executed by a machine, cause the machine to perform operations implementing any one of example methods 1 to 8.

What is claimed is:

1. A method comprising:
receiving an operation request for a virtual warehouse in a multi-tenant network-based data system;
transmitting the operation request for the virtual warehouse to a warehouse scheduling service dedicated to the virtual warehouse;
generating, by at least one hardware processor, a target state of the virtual warehouse based on the operation request for the virtual warehouse;
loading a current state of the virtual warehouse;
generating an action plan to converge the current state to the target state;
transmitting at least one allocation request to a server management service based on the action plan; and
iteratively executing steps of the action plan until the current state matches the target state.

2. The method of claim 1, wherein the multi-tenant network-based data system comprises a plurality of warehouse scheduling services, each warehouse scheduling service being dedicated to a different virtual warehouse.

3. The method of claim 1, wherein server management service is a single-node dedicated service and the multi-tenant network-based data system comprises a single server management service for managing a free pool of computing resources.

4. The method of claim 1, wherein the at least one allocation request comprises a plurality of allocation requests, each allocation request of the plurality of allocation request corresponding to a different cluster in the virtual warehouse.

5. The method of claim 1, further comprising:
receiving from the server management service a notification of partial completion of the at least one allocation request;
loading an updated current state of the virtual warehouse;
comparing the updated current state and the target state; and
transmitting at least a second allocation request to the server management service based on comparing the updated current state and the target state.

6. The method of claim 1, further comprising:
receiving a notification of a change to the target state that results in an updated target state;
loading a current state of the virtual warehouse based on the notification; and
generating an updated action plan to converge the current state to the updated target state.

7. The method of claim 6, wherein the target state is changed by a different component than the warehouse scheduling service.

8. The method of claim 1, wherein the operation request comprises a resume operation request.

9. A machine-storage medium embodying instructions that, when executed by a machine, cause the machine to perform operations comprising:
receiving an operation request for a virtual warehouse in a multi-tenant network-based data system;
transmitting the operation request for the virtual warehouse to a warehouse scheduling service dedicated to the virtual warehouse;
generating, by at least one hardware processor, a target state of the virtual warehouse based on the operation request for the virtual warehouse;
loading a current state of the virtual warehouse;
generating an action plan to converge the current state to the target state;
transmitting at least one allocation request to a server management service based on the action plan; and
iteratively executing steps of the action plan until the current state matches the target state.

10. The machine-storage medium of claim 9, wherein the multi-tenant network-based data system comprises a plurality of warehouse scheduling services, each warehouse scheduling service being dedicated to a different virtual warehouse.

11. The machine-storage medium of claim 9, wherein server management service is a single-node dedicated service and the multi-tenant network-based data system comprises a single server management service for managing a free pool of computing resources.

12. The machine-storage medium of claim 9, wherein the at least one allocation request comprises a plurality of allocation requests, each allocation request of the plurality of allocation request corresponding to a different cluster in the virtual warehouse.

13. The machine-storage medium of claim 9, further comprising:
receiving from the server management service a notification of partial completion of the at least one allocation request;
loading an updated current state of the virtual warehouse;
comparing the updated current state and the target state; and
transmitting at least a second allocation request to the server management service based on comparing the updated current state and the target state.

14. The machine-storage medium of claim 9, further comprising:
receiving a notification of a change to the target state that results in an updated target state;
loading a current state of the virtual warehouse based on the notification; and
generating an updated action plan to converge the current state to the updated target state.

15. The machine-storage medium of claim 14, wherein the target state is changed by a different component than the warehouse scheduling service.

16. The machine-storage medium of claim 9, wherein the operation request comprises a resume operation request.

17. A system comprising:
at least one hardware processor; and
at least one memory storing instructions that, when executed by the at least one hardware processor, cause the at least one hardware processor to perform operations comprising:
receiving an operation request for a virtual warehouse in a multi-tenant network-based data system;
transmitting the operation request for the virtual warehouse to a warehouse scheduling service dedicated to the virtual warehouse;
generating, by at least one hardware processor, a target state of the virtual warehouse based on the operation request for the virtual warehouse;
loading a current state of the virtual warehouse;
generating an action plan to converge the current state to the target state;
transmitting at least one allocation request to a server management service based on the action plan; and
iteratively executing steps of the action plan until the current state matches the target state.

18. The system of claim 17, wherein the multi-tenant network-based data system comprises a plurality of warehouse scheduling services, each warehouse scheduling service being dedicated to a different virtual warehouse.

19. The system of claim 17, wherein server management service is a single-node dedicated service and the multi-tenant network-based data system comprises a single server management service for managing a free pool of computing resources.

20. The system of claim 17, wherein the at least one allocation request comprises a plurality of allocation requests, each allocation request of the plurality of allocation request corresponding to a different cluster in the virtual warehouse.

21. The system of claim 17, the operations further comprising:
receiving from the server management service a notification of partial completion of the at least one allocation request;
loading an updated current state of the virtual warehouse;
comparing the updated current state and the target state; and
transmitting at least a second allocation request to the server management service based on comparing the updated current state and the target state.

22. The system of claim 17, the operations further comprising:
receiving a notification of a change to the target state that results in an updated target state;
loading a current state of the virtual warehouse based on the notification; and
generating an updated action plan to converge the current state to the updated target state.

23. The system of claim 22, wherein the target state is changed by a different component than the warehouse scheduling service.

24. The method of claim 17, wherein the operation request comprises a resume operation request.
